(19) United States
(12) Patent Application Publication
(10) Pub. No.: US 2006/0058081 A1
(43) Pub. Date: Mar. 16, 2006

(54) Cellular telephone caddy

(76) Inventor: Bruce A. Reichenbach, Aiea, HI (US)

Correspondence Address: Donald R. Schoonover, 4211 Rolling Hills Drive, Nixa, MO, 65714-8771, US

(21) Appl. No.: 10/950,154

(22) Filed: Sep. 27, 2004

(51) Int. Cl. H04M 1/00

(52) U.S. Cl. 455/575.8; 455/575.1

(57) ABSTRACT

A caddy for storing and supporting a cellular telephone includes a connection for electrically connecting the telephone to a headset that has an earpiece and a microphone. A winder/reeler is also included to store the cable associated with the headset.

### BACKGROUND OF THE INVENTION

1. Field of the Invention

The present invention relates to the general art of cellular telephones, and to the particular field of accessories for cellular telephones.

2. Description of the Related Art

Cellular telephone usage has become nearly ubiquitous in recent times. People often multi-task with one of the tasks being a conversation on their cell phone. During such multi-task operations, the person often needs his or her hands.

In fact, many States have laws that require drivers who operate cell phones while driving to use a hands-free system.

Therefore, there is a need for a system for supporting a cellular telephone so a user has his or her hands free to conduct other tasks.

To satisfy a hands-free requirement, many cell phones have special headset attachments. However, these attachments must be connected to the cell phone before use. In some cases, the cell phone must have special jacks to accommodate such equipment. Older cell phones may have the jacks but may not be readily adaptable for many headset systems.

Therefore, there is a need for a system that will easily adapt an existing cell phone to a hands-free system.

Many hands-free systems include cables or cords. These cables or cords often get in the way of other tasks and can be cumbersome to store when not in use. Such drawbacks often discourage people from using such systems or cause people to look for wireless connections that can be expensive and have other drawbacks.

Therefore, there is a need for a hands-free system for use with a cell phone that includes a cable which can be easily stored when the hands-free system is not in use.

### PRINCIPAL OBJECTS OF THE INVENTION

It is a main object of the present invention to provide a system for supporting a cellular telephone so a user has his or her hands free to conduct other tasks.

It is another object of the present invention to provide a system that will easily adapt an existing cell phone to a hands-free system.

It is another object of the present invention to provide a hands-free system for use with a cell phone that includes a cable which can be easily stored when the hands-free system is not in use.

### SUMMARY OF THE INVENTION

These, and other, objects are achieved by a cellular telephone caddy that has a headset and electrical connections for connecting the headset to the cellular telephone. A winder/reeler is also located in the caddy for automatically winding the wiring of the headset into the caddy for storage.

Using the cellular telephone caddy embodying the present invention permits a user to operate his or her cellular telephone in a hands-free manner without modifying the cellular telephone. The phone can be removed from the caddy and used in a normal manner, but can be used in a hands-free manner when in the caddy.

### BRIEF DESCRIPTION OF THE DRAWING FIGURES

FIG. 1 is a perspective view of a cellular telephone caddy embodying the present invention.

FIG. 2 is a cross-sectional view of the cellular telephone caddy shown in FIG. 1 taken along line 2-2 of FIG. 1.

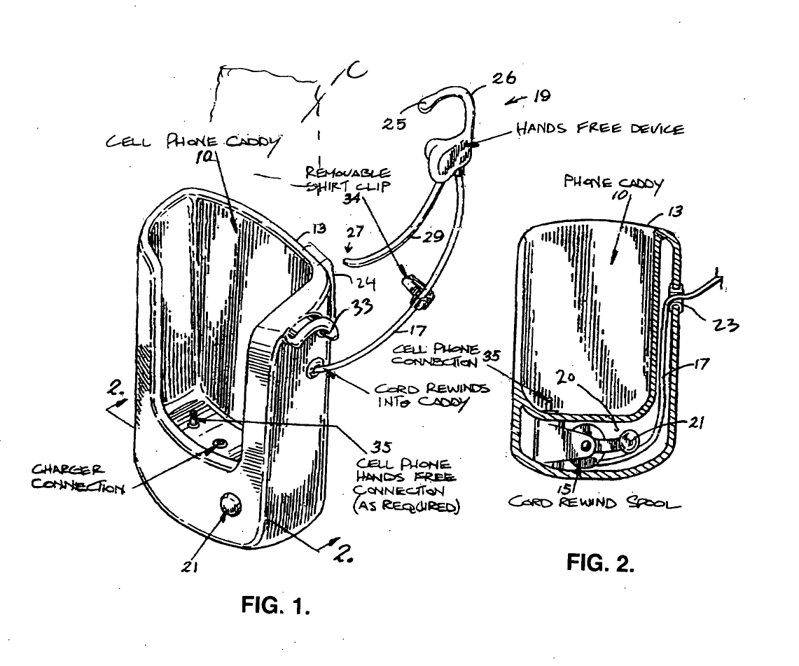

### DETAILED DESCRIPTION OF THE PREFERRED EMBODIMENT

Other objects, features and advantages of the invention will become apparent from a consideration of the following detailed description and the accompanying drawings.

Referring to the Figures, it can be understood that the present invention is embodied in a cellular telephone caddy 10 embodying the present invention.

Cellular telephone caddy 10 includes a rectangular cell phone case 13 which includes a reel/roller 15 to accommodate a cable 17 for a headset 19. Case 13 includes a cellular telephone storage area 20 that is sized and shaped to releasably accommodate a cellular telephone C. Phone C is not fully shown because those skilled in the art will understand the details of the phone C. The reel/roller 15 is located in a cord storage area 20′ and is controlled via a button 21 in a manner known from the prior art such as U.S. Pat. Nos. 5,938,137 and 6,578,683, the disclosures of which are incorporated herein by reference. The particular details of the reel/roller 15 are not part of the present invention, it is the presence of the reel/roller 15 that is important. Accordingly, the details of the reel/roller 15 will not be presented and will be understood by those skilled in the art based on the teaching of the present disclosure. A port 23 is defined through the case 13 adjacent to storage area 20′ and cable 17 extends through port 23. A mounting element, such as belt clip 24, or the like is fixed to case 13 to releasably attach case 13 to a user.

Case 13 allows cable 17 to of headset 19 to be plugged into cellular phone C and to be retracted by the use of the reel 15. Operation of the electrical connection between case 13 and cellular phone C will not be presented as the exact details of the circuits associated with such connection are not part of the present invention and will be understood by those skilled in the art based on the teaching of the present disclosure.

Headset 19 includes a small loudspeaker 25 in combination with an earpiece 26 and a microphone 27 mounted on a short swivel arm 29. When headset 19 is not in use, it is attached to case 13, such as by a hook-and-loop fastener mechanism or hooked over a hanger 33. An optional clip 34 may be used to attach cable 17 to a user's shirt.

Use of cellular telephone caddy 10 will be understood from the foregoing disclosure and thus will only be briefly described. A user places his or her cellular phone in case 13, attaches case 13 to his or her waistband, and hooks headset 19 over his or her ear. A connector 35 connects the cellular phone to cable 17 and headset 19. When needed, the user moves the swivel arm 29 to place microphone 27 in front of his or her mouth and makes or receives cellular telephone calls. After use, headset 19 is removed and cable 17 is retracted onto reel 15.

It is understood that while certain forms of the present invention have been illustrated and described herein, it is not to be limited to the specific forms or arrangements of parts described and shown.

What is needed and desired to be covered by Letters Patent is as follows:

1. A cellular telephone caddy comprising:
(a) a case unit which includes a phone storage area that is sized and adapted to accommodate a cellular telephone, a hollow cord storage area located adjacent to the phone storage area, an exit port defined through the case unit adjacent to the cord storage area, and a mounting element that is adapted to releasably mount said case unit on a user;
(b) a winder/reeler mechanism located in the cord storage area and including a control button;
(c) a cable attached to said winder/reeler mechanism and extending through the exit port in said case unit;
(d) an electrical connection element on said case unit in the phone storage area, said electrical connection element electrically connecting the cellular phone accommodated in the phone storage area to said cable when the cellular phone is accommodated in the phone storage area;
(e) a headset electrically connected to said cable and including a microphone and an earpiece which are electrically connected to the cellular telephone when the cellular telephone is accommodated in said case unit;
(f) a mounting clip on said cable; and
(g) a cable storage hanger element on said case adjacent to the exit port.
